(19) United States
(12) Patent Application Publication
(10) Pub. No.: US 2026/0066822 A1
(43) Pub. Date: Mar. 5, 2026

(54) ACTIVE LOSS GENERATION USING DISENGAGED MOTOR

(71) Applicant: Rivian IP Holdings, LLC, Irvine, CA (US)

(72) Inventors: Armin TEYMOURI, San Pedro, CA (US); Younes SANGSEFIDI, Irvine, CA (US); Mehrdad YAZDANIAN, Irvine, CA (US); Chia-Chou YEH, Torrance, CA (US)

(21) Appl. No.: 19/277,854

(22) Filed: Jul. 23, 2025

Related U.S. Application Data
(60) Provisional application No. 63/688,802, filed on Aug. 29, 2024.

(51) Int. Cl. H02P 21/36; B60K 1/02; B60K 11/02; B60L 7/16; B60L 15/00; B60L 58/12; H01M 10/42; H01M 10/46; H01M 10/48; H02P 21/18; H02P 21/22

(52) U.S. Cl. CPC H02P 21/36; B60K 1/02; B60L 7/16; B60L 15/007; B60L 58/12; H01M 10/46; H01M 10/486; H02P 21/18; H02P 21/22; B60K 11/02; B60L 2240/545; H01M 2010/4271; H02P 2207/05

(57) ABSTRACT

A power module includes inverter switches that are configured to control supply of current to a plurality of stator coils of a motor. A control module of the power module is configured to invoke supply of an amount of current to the motor by the inverter switches according to a current command while maintaining a rotor of the motor substantially still. For example, the control module may be configured to generate a ripple torque command alternating between positive and negative at a predefined period. The control module further generates a feedback torque command according to a feedback speed of the rotor in order to drive the speed of the rotor toward zero. The feedback torque command may be combined with the ripple torque command to obtain a total torque command.

### RELATED APPLICATION

This application claims priority to U.S. Provisional Application Ser. No. 63/688,802 filed Aug. 29, 2024 and entitled ACTIVE LOSS GENERATION USING DISENGAGED MOTOR.

### INTRODUCTION

The present disclosure relates to active loss generation using a disengaged motor.

### SUMMARY

The present disclosure describes an approach for inducing losses in a disengaged motor. In one aspect, inverter switches are configured to control supply of current to a plurality of stator coils of a motor. A control module is configured to cause the inverter switches to supply an amount of current to the motor according to a current command while maintaining a rotor of the motor substantially still. For example, the control module may be configured to generate a ripple torque command alternating between positive and negative at a predefined period.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3 is schematic block diagram illustrating a power module of a vehicle in accordance with certain embodiments.

FIG. 4 is a schematic diagram of components of a drive unit in accordance with certain embodiments.

FIG. 5 is schematic diagram illustrating the distribution of regeneration current in accordance with certain embodiments.

FIG. 6 is schematic block diagram of components for controlling current supplied to a disengaged motor in order to achieve active loss generation in accordance with certain embodiments.

### DETAILED DESCRIPTION

A vehicle includes multiple motors, one of which may be disengaged when not needed. The disengaged motor may still be used to generate active losses, such as to receive regenerative current when the battery is unable to receive regenerative current and to generate heat for conditioning the battery. A power module for controlling the supply of current to the disengaged motor generates a ripple torque command that alternates between positive and negative at a predefined period. A total torque command may be obtained by adding the ripple torque command to a feedback torque command based on a sensed speed of the motor, where the feedback torque command is selected to drive the speed of the motor toward zero. The total torque command and a current command are used to control inverter switches supplying current to the motor. The current command is an amount of current commanded to be drawn by the disengaged motor in order to absorb regenerative current and/or generate heat.

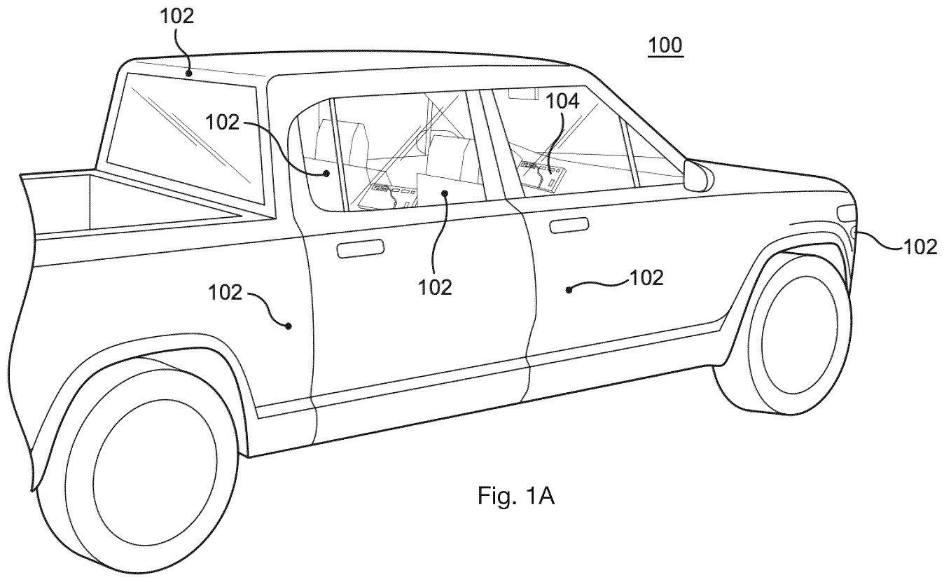

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (e.g., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power module 114, such as power module for each drive unit 112 or pair of drive units 112. The power module 114 may include inverters configured to convert direct current (DC) from the battery 110 into alternating current (AC) supplied to the motors of the drive units 112. The power module 114 further facilitates operation of the motors of the drive units as generators to provide regenerative braking. The power module 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIGS. 1B and 1n the discussion below, the vehicle 100 is a battery electric vehicle. However, a hybrid-electric vehicle may also benefit from the approach described herein. Likewise, non-vehicular applications that use an inverter or other relevant power component may also benefit from the approach described herein.

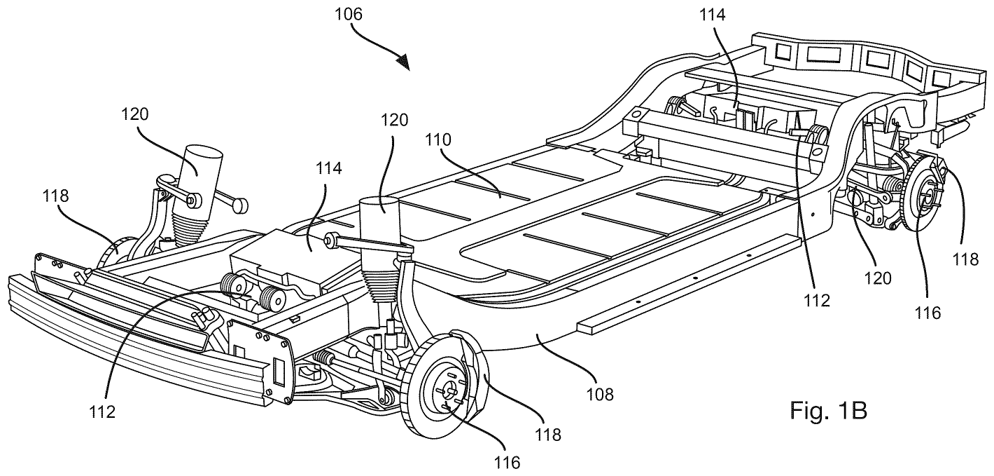

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of a power module 114, temperature of each drive unit 112 and/or each motor of each drive unit 112, temperature of coolant fluid entering or leaving a coolant system, temperature of oil within a drive unit 112, or the temperature of any other component of the vehicle 100. The temperature sensors 208 may include a temperature sensor directly mounted to a microprocessor of the power module 114 as described in greater detail below.

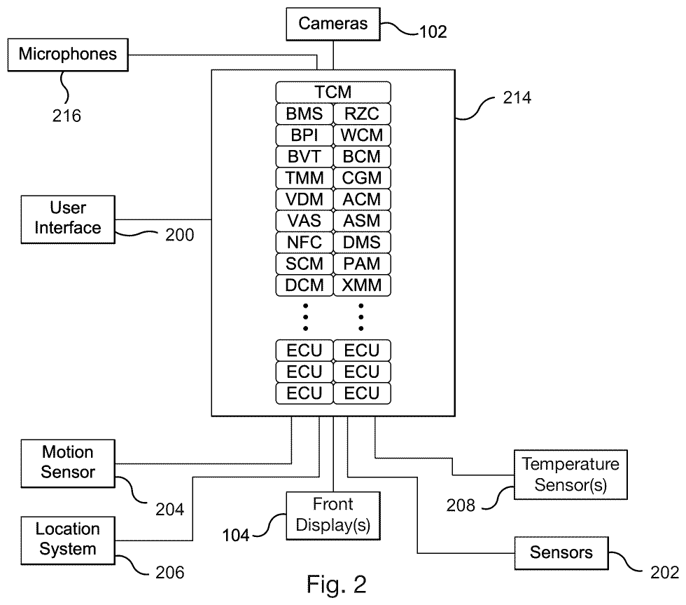

A control system 214 executes instructions to perform at least some of the actions or functions of the vehicle 100. For example, as shown in FIG. 2, the control system 214 may include one or more electronic control units (ECUs) configured to perform at least some of the actions or functions of the vehicle 100, including the functions described in relation to FIGS. 3 to 6. In certain embodiments, each of the ECUs is dedicated to a specific set of functions.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for processing.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

Referring to FIG. 3, the power module 114 may be contained within a housing 300, such as a housing made of aluminum or steel. The power module 114 may include a plurality of components configured to convert direct current (DC) from the battery 110 into alternating current (AC), such as three-phase AC, supplied to one or more motors 302 of the drive unit 112 including the power module 114.

The power module 114 may receive power from the battery 110 by way of a DC link capacitor 304 that is coupled to the positive and negative terminals (Batt+, Batt−) of the battery 110 and functions to smooth current received from the battery 110 as part of the process by which the direct current from the battery 110 is converted to an approximately sinusoidal alternating current. The DC link capacitor 304 may further function to dampen any voltage spikes. The DC link capacitor 304 may be within the housing 300 or external to the housing 300.

The power module 114 may include inverter switches 306 coupled to the outputs of the DC link capacitor 304. The inverter switches 306 may include a plurality of switches that are selectively opened and closed to cause transmission of current to the outputs of the power module 114 at an appropriate frequency for driving the one or more motors 302. For example, the inverter switches 306 may output three-phase current over lines 308 connecting the inverter switches 306 to the motor 302. The opening and closing of the switches of the inverter switches 306 may be controlled by a control module 310. The control module 310 may include a printed circuit board with various electronic components configured to generate the control signals for the inverter switches 306. In some embodiments, the power module 114 drives two drive units 112 and includes separate printed circuit boards for supplying current to the motors 302 of the separate drive units.

The control module 310 may further include a microprocessor 312 programmed to control operation of the control module 310 and therefore the inverter switches 306. The microprocessor 312 may be embodied as a silicon chip mounted to the printed circuit board of the control module 310. The microprocessor 312 may include a temperature sensor 314 mounted directly thereto.

The control module 310 may be coupled to the control system 214 and implement instructions from the control system 214 to control current supplied to the motor 302 and to cause the motor 302 to produce regenerative current. The control system 214 may generate such instructions as part of an automated driving algorithm (e.g., automatic cruise control), safety algorithm (e.g., traction control, stability control, automated emergency braking), or in response to inputs from a driver by way of an accelerator pedal 316 and/or brake pedal 318.

The motor 302 may include a rotor 322a and stator coils 322b. The stator coils 322b include loops of wire through which current is passed in order to induce stator magnetic fields that acts on the rotor 322a. The rotor 322a includes either (a) permanent magnets that are acted upon by the stator magnetic fields to induce torque on the shaft 322c of the motor 302 or (b) conductive rods in which current is induced by the stator magnetic fields, thereby creating a corresponding rotor magnetic field that reacts with the stator magnetic fields to induce torque on the shaft 322c.

When the rotor 322a includes permanent magnets, spinning of the rotor 322a when the motor 302 is not in use induces currents in the stator coils 322b and corresponding magnetic fields that resist spinning of the rotor 322a. It is therefore advantageous to disconnect the shaft 322c from the wheels of the vehicle 100 when the motor 302 is not in use.

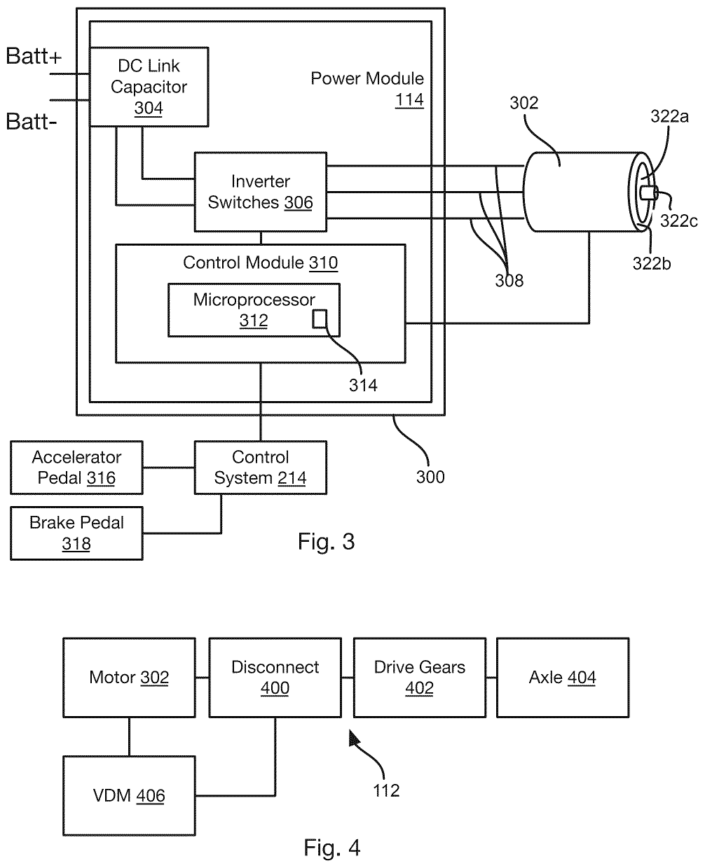

For example, referring to FIG. 4, the drive unit 112 may include a disconnect 400 interposed between the motor 302 and drive gears 402. The drive gears 402 transmit torque to an axle 404 coupled to one or more wheels of the vehicle 100. A vehicle dynamics module (VDM) 406 of the control system 214 is configured to control the supply of current to the motor 302 and to control the state of the disconnect 400, i.e., connecting the motor 302 to the drive gears 402 or disconnecting the motor 302 from the drive gears 402. The disconnect 400 may also be interposed between the drive gears 402 and the axle 404 or between the axle 404 and the one or more wheels of the vehicle 100.

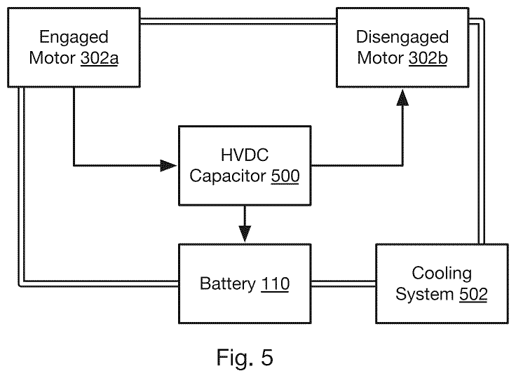

Referring to FIG. 5, the vehicle 100 may operate in the illustrated configuration in which one motor 302a is engaged, e.g., coupled to one or more first wheels of the vehicle 100 and another motor 302b is disengaged, e.g., not coupled to one or more second wheels of the vehicle 100. This configuration may be useful when torque from both motors 302a, 302b is not required to achieve a target speed of the vehicle 100 or when the vehicle 100 is operating in an energy conservation mode.

The drive unit 112 including the motor 302a may be configured such that the motor 302a is always engaged. In one example, the motor 302a is engaged with the front two wheels of the vehicle 100 and the motor 302b is selectively engaged with the rear two wheels of the vehicle 100. In some embodiments, the engaged motor 302a may be an induction motor whereas the disengaged motor 302b is a permanent magnet motor.

The motors 302a, 302b may be coupled to the battery 110 in order to send regenerative current to the battery 110 or receive current from the battery 110. In the illustrated embodiments, the motors 302a, 302b are coupled to the battery 110 by a capacitor 500, such as a high voltage direct current (HVDC) capacitor. The HVDC capacitor 500 may be a single capacitor to which both motors 302a, 302b are connected or separate HVDC capacitors 500 for each motor 302a, 302b (e.g., the DC link capacitor 304 of each drive unit 112).

During normal driving, the engaged motor 302a may periodically generate regenerative current, such as while performing regenerative braking. In some scenarios, the battery 110 is unable to receive the regenerative current, or the full amount of the regenerative current. This scenario may occur when the battery 110 is at or near a full state of charge (SOC) or when the battery temperature is too low or too high to receive current without causing damage to the battery 110. It may be desirable to maintain the amount of regenerative current higher than the capacity of the battery 110 in order to provide a consistent amount of stopping force (e.g., consistent amount of stopping force for a given amount of force applied to the brake pedal 318) independent of the condition of the battery 110.

In such a scenario, the disengaged motor 302b may be operated in a lossy manner in order to convert the current into heat. The heat may be dissipated by coolant circulated by a cooling system 502. The coolant may circulate coolant into thermal contact with the motors 302a, 302b and the battery 110. The cooling system 502 may include a radiator for exchanging heat with ambient air and possibly a chiller that is part of a vapor compression refrigeration system.

In another scenario, the battery 110 is below a desired temperature, whether for supplying current to the engaged motor 302a or for receiving current when charging the battery. In this scenario, the disengaged motor 302b may likewise be operated in a lossy manner in order to convert the current into heat that is conducted to the battery 110 by the cooling system 502.

Using the approach described herein, the disengaged motor 302b is operated in a lossy manner while also maintaining the rotor 322a substantially still, e.g., remaining within a 1, 0.1, or 0.01 degree range of positions. Operating the disengaged motor 302b in this manner facilitates reengagement of the motor 302b using the disconnect 400 by the VDM 406 when required. For example, the VDM 406 may presume that the rotor 322a is not rotating (e.g., a rotational speed less than 10, 5, or 1 revolution per minute (RPM)) and/or within a tolerance (e.g., 5, 1, or 0.1 degrees) of a known position when reengaging the motor 302b.

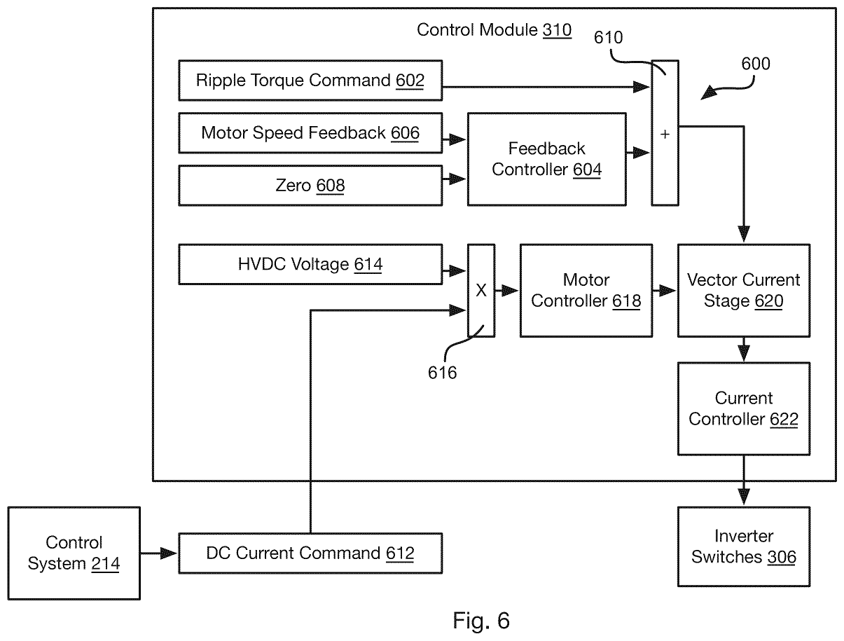

FIG. 6 illustrates an example control architecture 600 for operating the disengaged motor 302b in a lossy manner in either of the above-described scenarios. The illustrated control architecture 600 may be implemented by a power module 114, such as by the control module 310, of a power module 114, the power module 114 being part of a drive unit 112 including the disengaged motor 302b with the inverter switches 306 also being used as outlined below. The control architecture 600 may implement commands received from the control system 214, e.g., a command to consume an amount of current while maintaining the motor 302 of the drive unit 112 substantially still as defined above.

The control architecture 600 may be generally described as commanding an alternating torque (“ripple torque”) and zero speed for the disengaged motor 302b while also commanding a current draw corresponding to the amount of current required to one or both of (a) consume excess regenerative current that cannot be received by the battery 110 and (b) generate heat for conditioning the battery 110.

For example a ripple torque command 602 may command alternating positive and negative torques at a predefined period. The ripple torque command 602 may be generated by the control module 310 itself. The duration of periods of positive torque and negative torque may be substantially equal (within tolerances achievable by the components used, e.g., within 2% of equal) and together constitute 100% of the duration of the ripple torque command 602, e.g., 50% duty cycle for positive torque interleaved with 50% duty cycle for negative torque. The magnitude of the periods of positive torque and the periods of negative torque may be substantially equal (e.g., within tolerances achievable by the components used, e.g., within 2% of equal)

The magnitude and duration of the positive torque periods and negative torque periods may be based on a frequency response of the motor 302. For example, the magnitude and duration may be selected such that, when torque of the motor 302 is controlled solely according to the ripple torque command 602, the motor 302 will experience oscillations with a magnitude of less than one degree, 0.5 degrees, 0.1 degrees, or 0.01 degrees. In one example, the magnitude is selected to be between 20 Newton-meters (Nm) and 1 Nm, between 10 Nm and 1 Nm, or between 5 Nm and 1 Nm. The duration of each positive and negative period may be selected to be less than 100 milliseconds, 10 milliseconds, or 1 millisecond. In some embodiments, the duration is selected based on switching speed of components used, e.g., the switching speed of the inverter switches 306 or some multiple thereof (e.g., less than 4, 2, or a smaller multiple). The duration may be selected based on the maximum rotational speed of the motor 302b, e.g., a limit imposed by components controlling the speed of the motor 302b. For example, the duration may be 1/(M*R), where R is the maximum rotational speed in revolutions per seconds and M is a multiple, such as a value greater than 1, greater than 2, greater than 10, or greater than 100. In some embodiments, for example, the duration of the predefined period of the ripple current may be less than 1/M, where M is the maximum rotational speed of the motor in revolutions per second.

In some embodiments, speed feedback is used along with the ripple torque command 602 in order to account for inaccuracy in the generation and/or implementation of the torque command and to prevent the motor 302 from beginning to rotate. For example, a motor speed feedback signal 606 and a zero speed command 608 may be input to a feedback controller 604, such as a proportional-integral-derivative (PID) controller. The feedback controller 604 selects a feedback torque command according to a transfer function that will, over time, drive the motor speed feedback signal 606 toward zero. When the disengaged motor 302b is engaged, the zero speed command 608 may be replaced with a speed command from the control system 214 corresponding to an input from the user (e.g., position of the accelerator pedal 316) or an automated system (e.g., cruise control or other automated driving system).

The feedback torque command output from the feedback controller 604 may then be combined with the ripple torque command 602, such as by summing the ripple torque command 602 and the feedback torque command at a summing stage 610 to obtain a total torque command. The use of the ripple torque command 602 along with speed feedback may help avoid spinning of the rotor 302c during any delay in implementing speed feedback, such as transmission delays or the finite frequency response of the feedback controller 604.

A desired amount of loss may be determined from a DC current command 612 and an HVDC voltage 614. The DC current command 612 is, or is a function of, the amount of regenerative current currently being generated in excess of the capacity of the battery 110 to receive current. The DC current command 612 may additionally or alternatively be a function of an amount of heating of the battery 110 that is needed, e.g., a value that is obtained based on a sensed temperature of the battery 110, such as a temperature feedback controller. The HVDC voltage 614 may be a sensed value of the voltage at the output of the battery 110 (e.g., Batt+) or at input terminals of the disengaged motor 302b.

The DC current command 612 and the HVDC voltage 614 may be multiplied by one another, such as by multiplier stage 616, to obtain a power command, e.g., the amount of power that the disengaged motor 302b should consume.

The power command may be input to a motor controller 618, which outputs a corresponding input current command. For example, the motor controller 618 may be a controller that is used to convert a commanded amount of power (e.g., according to a position of the accelerator pedal 316) to a current requirement. The motor controller 618 may be implemented using a lookup table or other type of control algorithm. In other embodiments, the DC current command 612 is used as the input current command in bypass of the motor controller 618. Using the motor controller 618 has an advantage of using an existing programmable component of the control module 310. However, in other embodiments, another component may implement the functions ascribed herein to the motor controller 618 relating to generating loss while maintaining the motor 302 substantially still as defined above. For example, separate control module within the control module 310, power module 114, or control system 214 may be used in place of the motor controller 618.

The total torque command and the input current command may be input to a vector current stage 620. The vector current stage 620 determines the timing and amount of current applied to each coil of the stator coils 322b according to the total torque command and the input current command. The output of the vector current stage 620 may therefore be a signal for each stator coil 322b, each signal indicating a time varying current target for that stator coil 322b. The vector current stage 620 may be implemented as any vector current controller (e.g., a direct quadrature (DQ) controller) known in the art.

The output signals of the vector current stage 620 may be input to a current controller 622 that controls switches supplying current to the stator coils 322b in order to achieve the current targets specified in the output signals within the limitations of the current controller 622. The current controller 622 may be implemented as the inverter switches 306 or other component of the power module 114.

The feedback control based on the motor speed feedback signal 606 along with the ripple torque command 602 ensures that the rotor 302c remains substantially still. The control of the motor controller 618 according to the DC current command 612 ensures that the current drawn by the motor 302 (e.g., root-mean-square (RMS) current) is substantially equal to (e.g., within 10, 5, or 1 percent of) the DC current command 612.

As is apparent, the control architecture 600 enables a specified amount of current draw by the disengaged motor 302b while also performing feedback control to prevent the rotor 302c from rotating. The control architecture 600 may accomplish this with only one input from the VDM 406 of the control system 214: the DC current command 612. The control architecture 600 itself may be implemented within the control module 310 or by some other component within the power module 114 that is separate from the control system 214. For example, the control module 310 may implement the control architecture 600 in response to receiving the DC current command 612 while the motor 302b is disengaged.

Using the approach described above, the disengaged motor 302b may, for example, enable an additional 10 Nm of regenerative braking to be generated or generate 10 kilowatts of heat for conditioning of the battery. The approach described above may be limited by a temperature limit of the disengaged motor 302b. For example, if a temperature sensor indicates that the disengaged motor 302b is above a threshold temperature, the control module 310 may notify the VDM, which may then reduce the DC current command 612 in response to the notification. The VDM may take other actions in response to the notification, such as reducing regenerative braking, increasing friction braking, or drawing heat from another source to condition the battery (e.g., a resistive heater).

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

While the foregoing is directed to embodiments of the present disclosure, other and further embodiments may be devised without departing from the basic scope thereof, and the scope thereof is determined by the claims that follow.

What is claimed is:

1. A power module, comprising:
inverter switches configured to control supply of current to a plurality of stator coils of a motor; and
a control module configured to cause the inverter switches to supply an amount of current to the motor according to a current command and a torque command to maintain a rotor of the motor substantially still, the torque command including a ripple torque command alternating between positive and negative at a predefined period.

2. The power module of claim 1, wherein the predefined period is less than 10 milliseconds.

3. The power module of claim 1, wherein the torque command includes a feedback torque command, and the control module is further configured to:
receive a speed feedback signal indicating a speed of the motor;
generate the feedback torque command that drives the speed of the motor toward zero;
combine the ripple torque command and the feedback torque command to obtain the torque command; and
control the inverter switches based on the torque command.

4. The power module of claim 3, wherein the control module is further configured to generate the feedback torque command according to the speed feedback signal using a proportional-integrator-derivative feedback controller.

5. The power module of claim 3, wherein the control module is further configured to control the inverter switches according to the current command and the torque command such that the amount of current drawn by the motor is substantially equal to the current command while maintaining the rotor of the motor substantially still.

6. The power module of claim 3, wherein the control module is further configured to control the inverter switches according to the current command and the torque command such that the amount of current is within 10 percent of the current command while maintaining movement of a rotor of the motor within a 1 degree range of positions.

7. The power module of claim 3, wherein the control module is further configured to:
determine an input current according to the current command and a voltage of a battery coupled to the power module; and
generate a vector current according to the torque command and the input current, the vector current defining a timing and amount of current to be applied to each stator coil of the plurality of stator coils using the inverter switches.

8. A vehicle, comprising:
a plurality of wheels;
a motor;
a disconnect configured to selectively engage the motor with one or more first wheels of the plurality of wheels;
a power module configured to control the motor; and
a control system configured to:
instruct the disconnect to disengage the motor from the one or more first wheels; and
while the motor is disengaged from the one or more first wheels, output a current command to the power module;
wherein the power module is configured supply an amount of current to the motor according to the current command while maintaining a rotor of the motor substantially still.

9. The vehicle of claim 8, wherein:
the motor is a first motor, the vehicle further comprising a second motor coupled to one or more second wheels of the plurality of wheels; and
the control system is configured to determine the current command according to an amount of regenerative current generated by the second motor.

10. The vehicle of claim 9, further comprising a battery;
wherein the control system is configured to determine the current command according to the amount of regenerative current generated by the second motor and a current-receiving capacity of the battery.

11. The vehicle of claim 10, wherein the control system is configured to determine the current-receiving capacity of the battery according to a state of charge and a temperature of the battery.

12. The vehicle of claim 8, further comprising a battery and a cooling system coupled to the battery and to the motor;
wherein the control system is configured to determine the current command according to a temperature of the battery.

13. The vehicle of claim 12, wherein the cooling system is configured to circulate coolant into thermal contact with the battery and the motor.

14. The vehicle of claim 8, wherein the power module further comprises inverter switches, the power module being further configured to generate a ripple torque command alternating between positive and negative at a predefined period.

15. The vehicle of claim 14, wherein the predefined period is less than 10 milliseconds.

16. The vehicle of claim 14, wherein the power module is further configured to:
receive a speed feedback signal indicating a speed of the motor;
generate a feedback torque command determined to drive the speed of the motor toward zero;
combine the ripple torque command and the feedback torque command to obtain a total torque command; and
control the inverter switches based on the total torque command.

17. The vehicle of claim 16, wherein the power module is configured to generate the feedback torque command according to the speed feedback signal using a proportional-integrator-derivative feedback controller.

18. The vehicle of claim 16, wherein the power module is further configured to control the inverter switches according to the current command and the total torque command such that the amount of current is substantially equal to the current command while maintaining the rotor of the motor substantially still.

19. The vehicle of claim 16, wherein the power module is further configured to control the inverter switches according to the current command and the total torque command such that the amount of current is within 10 percent of the current command while maintaining movement of a rotor of the motor within a 1 degree range of positions.

20. The vehicle of claim 16, wherein the power module is further configured to:
determine an input current according to the current command and a voltage of a battery coupled to the power module; and
generate a vector current according to the total torque command and the input current, the vector current defining a timing and amount of current to be applied to each stator coil of the motor using the inverter switches.
